(19) United States
(12) Patent Application Publication
(10) Pub. No.: US 2014/0270758 A1
(43) Pub. Date: Sep. 18, 2014

(54) OPTICAL COMMUNICATION APPARATUS AND PCB INCLUDING OPTICAL INTERFACE FOR REALIZING CONCURRENT READ AND WRITE OPERATIONS

(71) Applicant: Samsung Electronics Co., Ltd., Suwon-Si (KR)

(72) Inventors: Amir Hossein Nejadmalayeri, Hwaseong-si (KR); Yoon Dong Park, Osan-si (KR); Hyun Il Byun, Seongnam-si (KR); In Sung Joe, Seoul (KR)

(73) Assignee: Samsung Electronics Co., Ltd., Suwon-Si (KR)

(21) Appl. No.: 14/211,040

(22) Filed: Mar. 14, 2014

(30) Foreign Application Priority Data
Mar. 15, 2013 (KR) 10-2013-0028320

(51) Int. Cl. H04L 5/14; H04J 14/06

(52) U.S. Cl. CPC H04L 5/14; H04J 14/06
USPC 398/41

(57) ABSTRACT

An optical communication apparatus and printed circuit board (PCB), which include an optical interface for realizing concurrent read and write operations, and a data processing system including a memory module and the PCB are provided. The optical communication apparatus includes an optical interface unit configured to output optical signal of first data and receive optical signal of second data simultaneously, and an optical bus configured to transmit the optical signals between the first optical interface unit and a second optical interface unit, the second optical interface unit being configured to receive the optical signal of the first data and output the optical signal of the second data simultaneously. The optical signal of the first data and the optical signal of the second data have polarizations, respectively, orthogonal to each other.

### CROSS-REFERENCE TO RELATED APPLICATIONS

This application claims priority under 35 U.S.C. §119(a) from Korean Patent Application No. 10-2013-0028320 filed on Mar. 15, 2013, the disclosure of which is hereby incorporated by reference in its entirety.

### BACKGROUND

Example embodiments of inventive concepts relate to a data processing system including a memory module and a printed circuit board (PCB), for example, a memory module and PCB, which includes an optical interface for realizing concurrent read and write operations, and/or a memory system including the memory module and the PCB.

For fast data transmission and reception, an optical communication bus as well as an electrical communication bus has been used for a processing unit memory bus. The use of the optical communication bus has increased data transmission speed and data reliability as well since less interference occurs in the optical communication bus than in the electrical communication bus.

However, when the processing unit transmits a read command and a write command to a memory module, the memory module transmits or receives only read data or write data through an optical waveguide and transmits or receives the other data later.

### SUMMARY

Some example embodiments provide an optical communication apparatus and printed circuit board (PCB), which are capable of transmitting and receiving read data and write data at a time using the polarization of an optical signal, and a data processing system including the memory module and the PCB.

Some example embodiments also provide a memory module and PCB, which is capable of independently transmitting and receiving data to and from another memory module using the wavelength characteristic of an optical signal, and a data processing system including the memory module and the PCB.

According to some example embodiments of inventive concepts, there is provided an optical communication apparatus including a first optical interface unit configured to output optical signal of first data and receive an optical signal of second data simultaneously, an optical bus configured to carry the optical signals between the first optical interface unit and a second optical interface unit, the second optical interface unit being configured to receive the optical signal of the first data and output the optical signal of the second data simultaneously.

The optical signal of the first data and the optical signal of the second data have polarizations, respectively, orthogonal to each other.

According to some example embodiments of inventive concepts, there is provided an optical communication apparatus including an optical waveguide configured to carry an optical signal of first data and receive an optical signal of second data simultaneously, a light source configured to convert the first data from an electrical signal to the optical signal, the optical signal of the first data having a first polarization, a polarization beam splitter configured to separate the optical signal of the first data from the optical signal of the second data according to at least the first polarization; and a photodetector configured to convert the optical signal of the second data to an electrical signal.

The first data may be a read data and the second data may be a write data.

The optical communication apparatus may further include a plurality of memory devices configured to store the write data and to read the read data.

The optical waveguide may be a data bus allowing full-duplex communication.

The first polarization may be a polarization parallel to a reference plane and the second polarization may be a polarization perpendicular to the reference plane.

According to some example embodiments of inventive concepts, there is provided a printed circuit board connected with a plurality of memory modules, the printed circuit board including a processing unit configured to output at least one of a read command, a write command and write data, an optical interface configured to convert the read command, the write command and the write data to optical signals and to transmit the optical signals, an address/command bus configured to transmit the optical signals of the read command and the write command and a data bus configured to transmit the optical signal of the write data and receive an optical signal of read data corresponding to the read command and to allow the optical signal of the write data and the optical signal of the read data to be simultaneously transmitted and received.

The printed circuit board accesses a target memory module on which the read command or the write command is executed according to a wavelength of each optical signal.

At least one example embodiment discloses a data processing system including at least one memory module, the memory module configured to receive write data and transmit read data simultaneously and a processor configured to optically communicate with the memory module.

### BRIEF DESCRIPTION OF THE DRAWINGS

The above and other features and advantages of inventive concepts will become more apparent by describing in detail example embodiments thereof with reference to the attached drawings in which:

FIG. 1 is a diagram of a data processing system according to an example embodiment of inventive concepts;

FIG. 2 is a diagram of a data processing system according to another example embodiment of inventive concepts;

FIG. 3 is a diagram of the operation of optical interfaces illustrated in FIG. 1;

FIG. 4 is a cross-sectional view of a memory module, which shows the structure of a second optical interface illustrated in FIG. 3;

FIGS. 5A through 5C are schematic diagrams of a read data transmission path and a write data transmission path according to different example embodiments of inventive concepts;

FIG. 6 is a diagram of the operation of the second optical interface according to an example embodiment of inventive concepts;

FIGS. 7A and 7B are block diagrams of a data processing system according to the example embodiment illustrated in FIG. 6;

FIG. 8 is a diagram of the operation of the second optical interface according to another example embodiment of inventive concepts;

FIGS. 9A and 9B are block diagrams of a data processing system according to the example embodiment illustrated in FIG. 8;

FIG. 10 is a diagram of a memory module according to an example embodiment of inventive concepts;

FIGS. 11A and 11B shows a polarization diversity coupler;

FIG. 12 is a diagram of a memory module according to an example embodiment of inventive concepts;

FIG. 13 is a diagram of a memory module according to an example embodiment of inventive concepts;

FIG. 14 is a diagram of a memory module according to an example embodiment of inventive concepts; and

FIGS. 15 through 18 are diagrams of the stages in a method of manufacturing a PU-memory bus according to an example embodiment of inventive concepts.

### DETAILED DESCRIPTION OF EXAMPLE EMBODIMENTS

Inventive concepts now will be described more fully hereinafter with reference to the accompanying drawings, in which example embodiments are shown. Inventive concepts may, however, be embodied in many different forms and should not be construed as limited to example embodiments set forth herein. Rather, example embodiments are provided so that this disclosure will be thorough and complete, and will fully convey the scope to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

FIG. 1 is a diagram of a data processing system 100 according to an example embodiment of inventive concepts. FIG. 2 is a diagram of a data processing system 100′ according to another example embodiment of inventive concepts.

Referring to FIGS. 1 and 2, the data processing system 100 and 100′ may include first optical communication devices 110 and 110′, respectively, a plurality of buses 101-1 and 101-2 and 102 and 101-3, respectively, and second optical communication devices 130 and 140, respectively. In some example embodiments, at least one of the first optical communication devices 110 and 110 may be a processing unit (PU), at least one of the plurality of buses 101-1 and 101-2 and 102 and 101-3 may be PU-memory buses, and at least one of the second optical communication devices 130 and 140 may be a memory module. However, the inventive concepts are not restricted to current embodiments. The data processing systems 100 and 100′ may be computers, portable computers, portable mobile communication devices, or consumer equipment (CE). The PU may be a central processing unit (CPU), a graphic processing unit (GPU), or a digital processing unit (DSP), but is not restricted thereto.

The portable mobile communication devices may include a mobile phone, a smart phone, a personal digital assistant (PDA), and a portable multimedia player (PMP). The CE may be a digital television (TV), a home automation system, or a digital camera. The PU 110 or 110′, the PU-memory buses 101-1 and 101-2 or 102 and 101-3, and a slot (not shown) may be mounted on a main board. Throughout the description, FIGS. 1-2 may be described using “or” such as the sentence above. Such language is used to describe both FIGS. 1-2 and the differences between FIG. 1-2 are generally described not using “or” and generally explicitly state the differences between FIGS. 1-2.

The PU-memory buses 101-1 and 101-2 and 102 and 101-3 may be positioned on the PU 110 and 110′ respectively, and a printed circuit board (PCB), within the PU 110 or 110′, or on a silicon die on which the PU 110 or 110′ is mounted in a package.

The PUs 110 and 110′ control the operation, e.g., the write operation or the read operation, of the memory modules 130 and 140, respectively. When memory devices 139 are non-volatile memory devices, the PU 110 may control the operation, e.g., the program operation, the write operation, the read operation, the erase operation, or the verify read operation, of the memory module 130. The memory module 130 may be inserted into a slot of a main board. Although only one slot and only one memory module 130 have been described with reference to FIGS. 1 and 2 for the sake of convenience, more than one slot may be included in the data processing systems 100 and 100′. A light source (not shown) may generate an optical signal for the transmission of data between the memory devices 139 mounted on the memory module 130 and the PU 110. The light source may be implemented within the PU 110 or the memory module 130. In an example embodiment, the light source may be implemented outside of the PU 110 or the memory module 130

A plurality of memory modules 130 may be provided. Each memory module 130 may transmit and receive data to and from the PU-memory buses 101-1 and 101-2 through a plurality of selectors 120 and 121. The address/command selector 121 may be implemented by an optical coupler, for example. In FIG. 2, an address/command selector 124 may be implemented by an electrical coupler.

Read/write data selectors 120 and 123 may be implemented by an optical coupler. The read/write data selectors 120 and 123 may select one of a plurality of memory dies in response to a wavelength. The read/write data selectors 120 and 123 may be manufactured using a thin film filter (TFF) that selectively reflects to an angled trench a particular wavelength only. The TFF may be implemented using glass, polymer, or other materials. An optical signal from the PU 110 to the memory module 130 and an optical signal from the memory module 130 to the PU 110 have the same wavelength, and therefore, the TFF may be shared for different operations.

The PU 110 includes a memory controller 112 and a first optical interface 115. The memory controller 112 may control the operation, e.g., the transmitting operation or the receiving operation, of the first optical interface 115 or 115′ under the control of the PU 110. The same applies to a first optical interface 115′ and the memory controller 112.

In the write operation, the first optical interface 115 may transmit an address signal and a control signal to the optical communication bus 101-1 under the control of the memory controller 112. In another example embodiment, the first optical interface 115′ may transmit the address signal and the control signal to the electrical communication bus 102 under the control of the memory controller 112.

The data buses 101-1, 101-2 and 101-3 illustrated in FIGS. 1 and 2 may be implemented by an optical communication bus. After transmitting the address signal and the control signal to the optical communication bus 101-1 or the electrical communication bus 102, the first optical interface 115 or 115′ may transmit write data to the optical communication bus 101-2 or 101-3.

The memory module 130 includes a second optical interface 135, an electrical interface 133, and a plurality of memory devices 137 and 139. The memory module 130 may be implemented by an optical dual in-line memory module (DIMM), an optical fully buffered DIMM (FB-DIMM), an optical small outline DIMM (SO-DIMM), an optical registered DIMM (RDIMM), an optical load reduced DIMM (LRDIMM), an unbuffered DIMM (UDIMM), an optical micro DIMM, or an optical single in-line memory module (SIMM). The PCB may be for an optical DIMM, an optical FB-DIMM, an optical SO-DIMM, an optical RDIMM, an optical LRDIMM, a UDIMM, an optical micro DIMM, or an optical SIMM.

Referring to FIG. 1, the second optical interface 135 transmits an address, a command, and write data from an optical communication bus to a photoelectric conversion module (not shown). The photoelectric conversion module may convert the address, the command, and the write data to electrical signals and may transmit the electrical signals to an input/output (I/O) unit 137 of at least one of the memory devices 139.

The memory devices 139 may include the I/O unit 137 that transmits and receives data between the interfaces 135 and 133 and each memory device 139, a memory array (not shown) including a plurality of memory cells, an access circuit (not shown) that accesses the memory array, and a controller (not shown) that controls the operation of the access circuit.

Referring to FIGS. 1 and 2, in the read operation, electrical signals output from the memory devices 139 or 149 are input to the electrical interface 133 or 143 and are converted to optical signals in the second optical interface 135 or 145. The optical signals are transmitted to the PU 110 or 110′ through the optical communication bus 101-2 or 101-3.

FIG. 3 is a diagram of the operation of the optical interface 135 and electrical interface 133 illustrated in FIG. 1. For the sake of convenience, it is assumed that a double-headed arrow indicates a polarization parallel to a reference plane and a circle with a dot indicates a polarization perpendicular to the reference plane. The reference plane may be the plane of drawing page (that is, sheet), but is not restricted thereto. The polarization parallel to the reference plane may be TE polarization and the polarization perpendicular to the reference may be TM polarization.

Referring to FIG. 3, the second optical interface 135 included in the memory module 130 includes a polarization beam splitter (PBS) 151. The first optical interface 115 included in the PU 110 also includes the PBS 151 and operates in the same manner as the second optical interface 135. The operation of the second optical interface 135 will be mainly described.

The PBS 151 splits light having orthogonal polarization. The PBS 151 may be implemented by a Glan-Thompson PBS, a Glan-Laser PBS, or a TFF. The PBS 151 may use a single optical waveguide or a plurality of optical waveguides, for example. In an example embodiment, one of the beams, that is, the light signal with TE polarization may go through the PBS 151 and another beam, that is, the light signal with TM polarization may be reflected by the PBS 151. So, light having orthogonal polarization may be separated. The PBS 151 may be used in each optical waveguide or may be shared by a plurality of optical waveguides. The PBS 151 separates data based on the polarization of an optical signal received through the optical communication bus 101-2 or 101-3 or the electrical interface 133 and outputs the separated data to the electrical interface 133 or the optical communication bus 101-2 or 101-3.

When receiving write data through the optical communication bus 101-2 or 101-3, the PBS 151 outputs the write data in a direction parallel to the reference plane, that is, the PBS 151 does not reflect the write data but outputs the write data to the electrical interface 133 according to the polarization of the write data. In a case where read data is output according to a read command, a light source mounted on the memory module 130 has fixed polarization when the read data is converted to an optical signal. The read data is transmitted in a direction perpendicular to the reference plane according to the polarization of the light source and is reflected by the PBS 151 to be transmitted to the optical communication bus 101-2 or 101-3.

The PBS 151 allows the transmission signal of the write data to be perpendicular to the transmission signal of the read data so that the write data has different polarization than the read data due to the characteristics of optical communication. As a result, interference is reduced. Consequently, the PU 110 can perform both the write operation and the read operation on the memory module 130 at the same time.

Alternatively, the PBS 151 may transmit the write data in the direction perpendicular to the side of the memory module 130 and transmit the read data in the direction parallel to the side of the memory module 130. In this case, the transmission signal of the write data and the transmission signal of the read data are separated from each other to be perpendicular to each other using the polarization of the light source and the PBS 151.

In an example embodiment, one of the polarizations (e.g., TM polarization) may be used for transferring write data from the PU 110 or 110′ to the memory module 130 or 140, and the other polarization (e.g., TE polarization) may be used for transferring read data from the memory module 130 or 140 to the PU 110 or 110′.

FIG. 4 is a cross-sectional view of the memory module 130, which shows the structure of the second optical interface 135 illustrated in FIG. 3. FIGS. 5A through 5C are schematic diagrams of a read data transmission signal and a write data transmission signal according to a different example embodiment of inventive concepts.

An internal optical waveguide 152 is connected to the PU-memory bus, i.e., the optical communication bus 101-2 illustrated in FIG. 1 or 101-3 illustrated in FIG. 2 through the selectors 120 and 121. For the sake of convenience, only the read/write data optical communication bus 101-2 is illustrated in FIG. 4. The memory module 130 includes a plurality of memory dies 139, a plurality of electrical interfaces 133, and the second optical interface 135. For the sake of convenience, only the second optical interface 135 is illustrated in detail. The second optical interface 135 includes the PBS 151, the internal optical waveguide 152 or WG, a laser source 153 or VC, and a photodetector 155 or PD. The internal optical waveguide 152 is a passage through data received from the optical communication bus 101-2 is transmitted. The PBS 151 splits a transmission signal according to the type of transmitted or received data, i.e., the polarization of read data or write data. When the read data is output from the memory module 130, the laser source 153 provides light used to convert the read data from an electrical signal to an optical signal. The photodetector 155 converts the write data from the optical signal to the electrical signal. The optical communication bus 101-2 is connected with the memory module 130 through the read/write data selector 120.

Upon receiving data from the optical communication bus 101-2, the read/write data selector 120 transmits the data to the memory module 130 corresponding to the wavelength of the data among a plurality of memory modules 130. Each memory module 130 communicates with the PU 110 using a specific wavelength different from wavelengths used by the other memory modules 130.

In detail, in the communication between a memory bank including a plurality of the memory modules 130 and the PU 110, when the PU 110 commands one of the memory modules 130 to do a write operation, a write command and write data are transmitted with a wavelength corresponding to the target memory module 130. When the write data corresponds to the wavelength of the target memory module 130 and the read/write data selector 120 connected to the PU-memory bus 101-2, the write data is transmitted to the target memory module 130. When the PU 110 commands a read operation, a read command is transmitted to the target memory module 130 and read data corresponding to the read command is transmitted to the PU 110 via the read/write data selector 120 through a transmission path.

Referring to FIGS. 5A through 5C, the read operation and the write operation may be performed separately or simultaneously and a write data transmission signal and a read data transmission signal have different polarization. For the sake of convenience, it is assumed that a double-headed arrow indicates a polarization parallel to the reference plane and a circle with a dot indicates a polarization perpendicular to the reference plane. The reference plane may be the plane of drawing page (that is, sheet), but is not restricted thereto. The polarization parallel to the reference plane may be TE polarization and the polarization perpendicular to the reference may be TM polarization

Referring to FIG. 5A, optical signal type write data generated by a light source LS at the PU 110 is reflected by a PBS included in the first optical interface 115 to be transmitted in a direction parallel to the side of a PCB on which the PU 110 is mounted. In the target memory module 130, the write data is reflected by the PBS 151 to the photodetector PD. Optical signal type read data generated by a light source LS at the memory module 130 is transmitted without being reflected through the PBS 151 in the second optical interface 135 in a direction perpendicular to the reference plane to the PU 110. In the PU 110, the read data is input without being reflected through the PBS included in the first optical interface 115 to a photodetector PD.

Referring to FIG. 5B, optical signal of write data generated by a light source LS at the PU 110 is reflected by a PBS included in the first optical interface 115 to be transmitted in a direction perpendicular to the side of a PCB on which the PU 110 is mounted. In the target memory module 130, the write data is reflected by the PBS 151 to the photodetector PD. Optical signal of read data generated by a light source LS at the memory module 130 is transmitted without being reflected through the PBS 151 in a direction parallel to the reference plane to the PU 110. In the PU 110, the read data is input without being reflected through the PBS included in the first optical interface 115 to a photodetector PD.

Differently from the embodiments illustrated in FIGS. 5A and 5B, in the embodiments illustrated in FIG. 5C, the positions of a light source LS and a photodetector PD may be exchanged at the PU 110. In this case, optical signal of write data generated by the light source LS at the PU 110 is transmitted without being reflected through a PBS included in the first optical interface 115 in a direction parallel to the side of a PCB on which the PU 110 is mounted. In the target memory module 130, the optical signal of the write data is reflected by the PBS 151 to the photodetector PD. Optical signal of the read data generated by a light source LS at the memory module 130 is transmitted without being reflected through the PBS 151 in a direction perpendicular to the reference plane to the PU 110. In the PU 110, the read data transmission signal is reflected by the PBS included in the first optical interface 115 to the photodetector PD.

In other words, using the PBS, the write data transmission signal is made to be parallel to the side of both the PU 110 and the memory module 130 in the example embodiment illustrated in FIG. 5A, is made to be perpendicular to the side of both the PU 110 and the memory module 130 in the example embodiment illustrated in FIG. 5B, and is made to be perpendicular to the side of one of the PU 110 and the memory module 130 and parallel to the side of the other of the PU 110 and the memory module 130 in the example embodiment illustrated in FIG. 5C.

FIG. 6 is a diagram of the operation of a second optical interface according to an example embodiment of inventive concepts. FIGS. 7A and 7B are block diagrams of a data processing system according to the example embodiment illustrated in FIG. 6. Referring to FIG. 6, the photodetector 155 and the light source LS are arranged side by side to be parallel to the side of the memory module 133.

It is assumed that a data transmission path for a read data transmission signal and a write data transmission signal is parallel to the side of the memory module 130. It is assumed that a write data transmission signal has polarization perpendicular to the read data transmission signal polarization.

Write data is input to the target memory module 130 through the optical communication bus or data bus 101-2 among PU-memory buses mounted on a PCB. The read/write data selector 120 reflects the write data to the target memory module 130 having a wavelength corresponding to the write data. At this time, since the write data transmission signal (that is, optical signal of the write data) has the polarization parallel to the reference plane, the write data transmission signal passes through the PBS 151 without being reflected and then reflected by a reflector 154 to the photodetector 155. The photodetector 155 converts the write data transmission signal from an optical signal to an electrical signal and transmits the electrical signal to one of the memory devices 139.

Read data converted by the light source LS to an optical signal has polarization perpendicular to the reference plane. Accordingly, the PBS 151 reflects the read data transmission signal to be transmitted to the PCB through the optical waveguide 152. The read/write data selector 120 reflects the read data transmission signal to be transmitted to the PU 110 through the data bus 101-2.

Alternatively, the write data transmission signal has polarization perpendicular to the reference signal and the read data transmission signal has polarization parallel to the reference plane.

Referring to FIGS. 7A and 7B, the memory module 130 includes a plurality of the memory devices 139 each having an I/O unit 137, the electrical interface 133 accessing the memory devices 139, and a second optical interface. The second optical interface includes the photodetector 155 or PD, the light source 153 or VC, the PBS 151, the reflector 154, and the internal optical waveguide 152. As described with reference to FIG. 6, referring to FIG. 7B, the light source 153 and the photodetector 155 are arranged side by side, and therefore, the PBS 151 and the reflector 154 are arranged side by side below the light source 153 and the photodetector 155, respectively. The second optical interface has a transparent window 156 which transmits and receives optical signal, but the electrical interface 133 has no transparent window.

FIG. 8 is a diagram of the operation of a second optical interface according to another example embodiment of inventive concepts. FIGS. 9A and 9B are block diagrams of a data processing system according to the embodiments illustrated in FIG. 8. Unlike FIG. 6, in the second optical interface of FIG. 8 includes a photodetector 155′ and a light source 153′ or LS arranged to be orthogonal to each other in a z-direction perpendicular to the side of the memory module 130.

It is assumed that the write data transmission signal has polarization parallel to the reference plane and the read data transmission signal has polarization perpendicular to the reference plane.

Write data is input to the target memory module 130 through the data bus 101-2 among PU-memory buses mounted on a PCB. The read/write data selector 120 reflects the write data to the target memory module 130 having a wavelength corresponding to the write data. At this time, the write data transmission signal has the polarization parallel to the side of the memory module 130, but the photodetector 155′ is positioned in the z-direction perpendicular to the side, i.e., x-y side of the memory module 130, and therefore, the write data is passed through the PBS 151 without being reflected and then input to the photodetector 155′ along an internal optical waveguide 152′. The photodetector 155′ converts the write data from an optical signal to an electrical signal and transmits the electrical signal to one of the memory devices 139.

The light source 153′ or LS is positioned in the z-direction perpendicular to the x-y side of the memory module 130 and read data converted by the light source LS to an optical signal has polarization perpendicular to the side of the memory module 130. Therefore, the PBS 151 reflects the read data to be transmitted to the PCB through the internal optical waveguide 152′. The read/write data selector 120 reflects the read data to be transmitted to the CPU 110 through the data bus 101-2.

Alternatively, the write data transmission signal has polarization perpendicular to the reference plane and the read data transmission signal has polarization parallel to the reference plane.

Referring to FIGS. 9A and 9B, the memory module 130 includes a plurality of the memory devices 139 each having an I/O unit 137, the electrical interface 133 accessing the memory devices 139, and a second optical interface. The second optical interface includes the photodetector 155′ or PD, the light source 153′ or VC, the PBS 151, and the internal optical waveguide 152′. Referring to FIGS. 8 and 9A, the light source 153′ and the photodetector 155′ are arranged to be orthogonal to each other instead of being side by side. Referring to FIG. 9B, the PBS 151 is positioned below the light source 153′. Differently from the example embodiments illustrated in FIG. 6 and FIGS. 7A and 7B, in the example embodiments illustrated in FIG. 8 and FIGS. 9A and 9B, the internal optical waveguide 152′ extends to the photodetector 155′ without having any reflector. The second optical interface has a transparent window 156 which transmits and receives optical signal, but the electrical interface 133 has no transparent window.

FIG. 10 is a diagram of a memory module according to an example embodiment of inventive concepts. Referring to FIG. 10, the memory module 130A may include an electrical interface 133A, an optical interface 135A, a memory device 137A, and an internal optical waveguide 152A. Each of the electrical interface 133A, the optical interface 135A, the memory device 137A, and the internal optical waveguide 152A may have similar structure and operations of the electrical interface 133, the optical interface 135, the memory device 137 and 139, and the internal optical waveguide 152, respectively. Thus, differences between the memory module 130A and memory module 130 will be mainly described to avoid redundancy.

In FIG. 10, the electrical interface 133A and the optical interface 135A may be implemented onto separate dies, but, may be co-packaged together. The memory device 135A may be implemented onto separate chip or die. The memory device 137A may be dynamic random access memory (DRAM), static random access memory (SRAM), flash memory, phase-change RAM (PRAM), magnetoresistive RAM (MRAM), resistive RAM (ReRAM), ferroelectric RAM (FeRAM) or any type of memory. In some embodiments that the memory module 130A includes a plurality of memory devices 137A, the plurality of memory devices 137A may be different memory types.

The optical interface 135A may include a polarization diversity coupler illustrated in FIG. 11A or FIG. 11B. Referring to FIG. 11A, the polarization diversity coupler 170A may include a structured vertical coupler 171, two tapers 181 and 182, and two waveguides 191 and 192. The polarization diversity coupler 170A may convert and output polarization of an input optical signal, For example, the polarization diversity coupler 170A may receive a first optical signal having TM polarization via a first waveguide 191 and a first taper 181, convert the polarization of the first optical signal to TE polarization, and output a second optical signal having TE polarization toward a second taper 182 and a second waveguide 192. The first optical signal having TM polarization may be generated from an optical transmitter. The optical transmitter may be implemented as a Mach-Zehnder modulator or a ring resonator modulator, but is not restricted thereto. The second optical signal having TE polarization may be received by an optical receiver. The optical receiver may be implemented as a Ge photodetector, or Si defect detector, but is not restricted thereto. In an example embodiment, each polarization is directed toward one of the waveguides, determined by the topology of the structured vertical coupler 171.

Referring to FIG. 11B, the polarization diversity coupler 170B may include a structured vertical coupler 171, two tapers 181 and 182, and two waveguides 191 and 192. The polarization diversity coupler 170B may convert and output polarization of an input optical signal, For example, the polarization diversity coupler 170B may receive a first optical signal having TE polarization via a first waveguide 191 and a first taper 181, convert the polarization of the first optical signal to TM polarization, and output a second optical signal having TM polarization toward a second taper 182 and a second waveguide 192. The first optical signal having TE polarization may be generated from an optical transmitter. The second optical signal having TM polarization may be received by an optical receiver. The optical receiver may be implemented as a Ge photodetector, or Si defect detector, but is not restricted thereto. In an example embodiment, each polarization is directed toward one of the waveguides, determined by the topology of the structured vertical coupler 171.

FIG. 12 is a diagram of a memory module according to an example embodiment of inventive concepts. Referring to FIG. 12, the memory module 130B may include an integrated electrical and optical interface 133B, a memory device 137B, a transparent window 156B and an internal optical waveguide 152B. Each of the memory device 137B, the transparent window 156B and the internal optical waveguide 152B may have similar structure and operations of the memory device 137A, the transparent window 156A and the internal optical waveguide 152A, respectively. Thus, differences between the memory module 130B and memory module 130A will be mainly described to avoid redundancy.

In FIG. 12, the electrical interface and the optical interface may be implemented onto a common die as the integrated electrical and optical interface 133B. The memory device 137B may be implemented onto separate chip or die. The integrated electrical and optical interface 133B may include the polarization diversity coupler 170A or 170B illustrated in FIG. 11A or FIG. 11B.

FIG. 13 is a diagram of a memory module according to an example embodiment of inventive concepts. Referring to FIG. 13, the memory module 130C may include an integrated electrical and optical interface 133C, a memory device 137C, a transparent window 156C and an internal optical waveguide 152C. In this embodiment, the integrated electrical and optical interface 133C may be implemented onto a common die. The memory device 137C may be implemented onto separate chip or die. However, all of them may be co-packaged. The integrated electrical and optical interface 133C may include the polarization diversity coupler 170A or 170B illustrated in FIG. 11A or FIG. 11B.

FIG. 14 is a diagram of a memory module according to an example embodiment of inventive concepts. Referring to FIG. 14, the memory module 130D may include an integrated interface and memory 133D, a transparent window 156D and an internal optical waveguide 152D. Each of the transparent window 156C and the internal optical waveguide 152C may have similar structure and operations of the memory device 137A, the transparent window 156A and the internal optical waveguide 152A, respectively. Thus, differences between the memory module 130C and memory module 130B will be mainly described to avoid redundancy.

In FIG. 14, the electrical interface, the optical interface and memory device 133D may be all fabricated on a common die. The integrated interface and memory 133D may include the polarization diversity coupler 170A or 170B illustrated in FIG. 11A or FIG. 11B.

FIGS. 15 through 18 are diagrams of the stages in a method of manufacturing a PU-memory bus according to example embodiments of inventive concepts. For the sake of convenience in the description, FIGS. 15 through 18 show the side view, the front view, and/or the top view of the stages.

Referring to FIG. 15, a plurality of optical waveguides 201-1 through 201-N, which will be used as the data bus 101-2, are implemented in a PCB 200. At this time, the optical waveguides 201-1 through 201-N (where N is a natural number of at least 1) may be implemented as a full-duplex channel and as many as the number of the memory devices 139 included in the memory module 130. In addition, positions 203-1 through 203-M (where M is a natural number of at least 1) for respective memory modules are set in the PCB 200.

Referring to FIG. 16, holes 204-1 through 204-NM are made at respective intersections between the optical waveguides 201-1 through 201-N and the positions for the memory modules. The holes 204-1 through 204-NM are charged with curable polymer in order to form an internal optical waveguide in a vertical direction. Curable polymer is made into an optical waveguide using thermal curing or ultra-violet (UV) curing. However, a method of forming the internal optical waveguide is not restricted to the current embodiment. The internal optical waveguide may be formed using many different methods.

Referring to FIG. 17, a slanted hole 205 is made from a point a predetermined distance away from a vertical optical waveguide to an intersection between each hole 204 and a horizontal optical waveguide 201. Slanted holes 205-1 through 205-M are made at the respective positions set for the respective memory modules.

Referring to FIG. 18, TFFs 206-1 through 206-M respectively having different wavelengths are implanted in the slanted holes 205-1 through 205-M, respectively. For instance, the TFF 206-1 implanted in the first memory module 203-1 has a different wavelength than the TFFs 206-2 through 206-M respectively implanted in the memory modules 203-2 through 203-M. As a result, when communicating with the PU 110, each memory module 130 selectively takes only data, which is transmitted and received with a specific wavelength of the memory module 130, without being interfered with by the operation of other memory modules 130.

Example embodiments of inventive concepts described with reference to FIGS. 1 through 13, that is, inventive concepts that an optical signal is transmitted and received between an optical interface in a memory package and an optical interface in a PCB may be applied regardless of a type of a memory device mounted on a memory module.

As described above, according to some example embodiments of inventive concepts, a memory module separates a write data transmission signal from a read data transmission signal according to the polarization of data, thereby transmitting read data and receiving write data simultaneously. In addition, a PCB separates a write data transmission signal from a read data transmission signal according to the polarization of data, thereby transmitting read data transmission signal and receiving write data transmission signal simultaneously. Also, the PCB transmits and receives data using an optical signal with a different wavelength for each memory module, thereby transmitting and receiving the read/write data transmission signal independently from the other memory modules.

While inventive concepts have been particularly shown and described with reference to example embodiments thereof, it will be understood by those of ordinary skill in the art that various changes in forms and details may be made therein without departing from the spirit and scope of inventive concepts as defined by the following claims.

1.-2. (canceled)

3. An optical communication apparatus comprising:
an optical waveguide configured to carry an optical signal of first data and receive an optical signal of second data simultaneously;
a light source configured to convert the first data from an electrical signal to the optical signal of the first data, the optical signal of the first data having a first polarization;
a polarization beam splitter configured to separate the optical signal of the first data from the optical signal of the second data according to at least the first polarization; and
a photodetector configured to convert the optical signal of the second data to an electrical signal,
wherein the optical signal of the second data has a second polarization, and the first polarization and the second polarization are orthogonal to each other.

4. The optical communication apparatus of claim 3, wherein the first data is read data and the second data is write data, and the optical communication apparatus further comprises:
a plurality of memory devices configured to store the write data and to read the read data.

5. The optical communication apparatus of claim 3, wherein the optical waveguide is a data bus configured to allow full-duplex communication.

6. The optical communication apparatus of claim 4, wherein the first polarization is parallel to a reference plane and the second polarization is perpendicular to the reference plane.

7. The optical communication apparatus of claim 4, further comprising:
a reflector below the photodetector and configured to reflect the optical signal of the write data when the light source and the photodetector are parallel to each other,
wherein the reflector is configured to reflect the optical signal of the write data to the photodetector, the polarization beam splitter is configured to reflect the optical signal of the read data and output the optical signal of the read data through the optical waveguide, and the polarization beam splitter is below the light source.

8. The optical communication apparatus of claim 4, wherein when the light source and the photodetector are parallel to each other, the photodetector is configured to receive the optical signal of the write data through the optical waveguide, the polarization beam splitter is configured to reflect the optical signal of the read data and output the optical signal of the read data through the optical waveguide, and the polarization beam splitter is below the light source.

9. A printed circuit board connected with a memory module, the printed circuit board comprising:
a processing unit configured to output at least one of a read command, a write command and write data;
an optical interface configured to convert the read command, the write command and the write data to optical signals and to transmit the optical signals;
an address/command bus configured to carry the optical signals of the read command and the write command; and
a data bus configured to simultaneously carry the optical signal of the write data and an optical signal of read data corresponding to the read command between the processing unit and the optical interface,
wherein the printed circuit board is configured to access a target memory module according to a wavelength corresponding to the target memory module.

10. The printed circuit board of claim 9, wherein the optical interface comprises:
a light source configured to convert the read data from an electrical signal of the read data to the optical signal of the read data, the optical signal of the read data has a polarization and the wavelength;
an optical waveguide configured to carry the optical signal of the write data and receive the optical signal of the read data simultaneously;
a polarization beam splitter configured to separate the optical signal of the read data from the optical signal of the write data according to at least the polarization of the optical signal of the read data; and
a photodetector configured to convert the optical signal of the write data to an electrical signal of the write data.

11. The printed circuit board of claim 9, further comprising:
an address/command selector configured to select the target memory module from among a plurality of memory modules and to transmit at least one of the optical signal of the read command and the optical signal of the write command; and
a read/write data selector configured to transmit at least one of the optical signal of the write data and the optical signal of the read data between the processing unit and the target memory module.

12. The printed circuit board of claim 11, wherein the read/write data selector is implemented by a slanted thin film filter having a different wavelength associated with each of the memory modules.

13. The printed circuit board of claim 12, wherein the read/write data selector is configured to reflect the optical signal of the write data received through the data bus to the target memory module only when the optical signal of the write data has the wavelength corresponding to the target memory module.

14. The printed circuit board of claim 9, wherein the optical signal of the read data and the optical signal of the write data have polarizations orthogonal to each other and have the same wavelength.

15. The printed circuit board of claim 9, wherein the optical signal of the read data has a polarization parallel to a reference plane and the optical signal of the write data has a polarization perpendicular to the reference plane.

16. A data processing system comprising:
at least one memory module, the memory module configured to receive write data and transmit read data simultaneously; and
a processor configured to optically communicate with the memory module.

17. The data processing system of claim 16, wherein the write data and read data are optical signals having different polarizations.

18. The data processing system of claim 17, wherein the memory module is configured to reflect the optical signal representing the write data.

19. The data processing system of claim 18, wherein the memory module is configured to transmit the optical signal representing the read data without reflection.

20. The data processing system of claim 16, further comprising:
a plurality of memory modules, the plurality of memory modules including the memory module, each of the plurality of memory modules associated with a different wavelength, wherein the processor is configured to transmit a signal to a selected one of the plurality of memory modules, the signal having the wavelength associated with only the selected memory module of the plurality of memory modules.
